(19) United States
(12) Patent Application Publication
(10) Pub. No.: US 2016/0112121 A1
(43) Pub. Date: Apr. 21, 2016

(54) OPTICAL COMPONENT, BUILT-IN OPTICAL TIME DOMAIN REFLECTOMETER, AND OPTICAL NETWORK DEVICE

(71) Applicants: Huawei Technologies Co., Ltd., Shenzhen (CN); Wuhan Huagong Genuine Optics Tech Co., Ltd., Wuhan (CN)

(72) Inventors: Zhicheng YE, Wuhan (CN); Gongzhi LIU, Wuhan (CN)

(21) Appl. No.: 14/982,315

(22) Filed: Dec. 29, 2015

Related U.S. Application Data
(63) Continuation of application No. PCT/CN2013/081540, filed on Aug. 15, 2013.

(51) Int. Cl. H04B 10/071; H04B 10/2507; G02B 6/42

(52) U.S. Cl. CPC H04B 10/071; G02B 6/4285; G02B 6/4215; G02B 6/4214; G02B 6/4246; G02B 6/4207; H04B 10/2507

(57) ABSTRACT

An optical component, including: a component base, a transmitter module connected to the component base, a receiver module, and a pigtail, where: the component base has a cavity, and a wave filtering sheet is provided inside the cavity; the transmitter module is configured to transmit a first optical signal to the pigtail; the receiver module is configured to receive a second optical signal from the pigtail; the wave filtering sheet is configured to transmit the first optical signal transmitted by the transmitter module, to enable the first optical signal to enter the pigtail; and is further configured to reflect the second optical signal received by the pigtail to the receiver module; and a reflecting light guide through-hole is opened on the component base along an optical path direction that the light filtering sheet reflects the first optical signal.

### CROSS-REFERENCE TO RELATED APPLICATIONS

This application is a continuation of International Patent Application No. PCT/CN2013/081540, filed on Aug. 15, 2013, which is hereby incorporated by reference in its entirety.

### TECHNICAL FIELD

The present disclosure relates to the field of optical fiber technologies, and in particular, to an optical component, a built-in optical time domain reflectometer, and an optical network device.

### BACKGROUND

Fiber to the home is an irresistible trend of the development of an access system, but cost of the entire system must be lowered to gain popularity. Therefore, under the premise of not increasing component cost, the requirement of an integration level of an optical component is higher and higher. For example, a built-in Optical Time Domain Reflectometer (OTDR) integrates a sending part and a receiving part into a same optical component, where a sent signal and a received signal have a same wavelength, and are split by a splitter.

Optical crosstalk exists in the optical component, and the optical crosstalk may directly affect performance of the entire optical component. In the optical component, the crosstalk among signals of different wavelengths is interband crosstalk, and such crosstalk is easy in separation. For example, for a Gigabit Passive Optical Network (GPON), the sent signal and received signal thereof respectively adopt different wavelengths. Crosstalk among signals of a same wavelength is intraband crosstalk, and such crosstalk is difficult to separate. For example, for a built-in OTDR, the sent signal and received signal thereof adopt a same wavelength.

However, the receiving part of the built-in OTDR needs to monitor optical fiber reflected light, and the optical fiber reflected light is very weak. Therefore, a target demand of the built-in OTDR for the optical crosstalk is very strict, and generally is at least −35 dB.

Therefore, how to eliminate optical crosstalk in the optical component of the built-in OTDR and improve overall performance of the optical component is a technical problem in dire need of solution for persons skilled in the art.

### SUMMARY

Embodiments of the present disclosure provide an optical component, a built-in optical time domain reflectometer, and an optical network device, which can effectively eliminate optical crosstalk in the optical component and improve overall performance of the device.

In a first aspect, an optical component is provided, including: a component base, a transmitter module connected to the component base, a receiver module, and a pigtail; where the component base has a cavity, and a wave filtering sheet is provided inside the cavity;

the transmitter module is configured to transmit a first optical signal to the pigtail;

the receiver module is configured to receive a second optical signal from the pigtail;

the wave filtering sheet is configured to transmit the first optical signal transmitted by the transmitter module, to enable the first optical signal to enter the pigtail; and is further configured to reflect the second optical signal received by the pigtail to the receiver module; and

a reflecting light guide through-hole is opened on the component base along an optical path direction that the light filtering sheet reflects the first optical signal.

In a first possible implementation of the first aspect, the reflecting light guide through-hole is provided with a wave-absorbing sheet additionally.

With reference to the first possible implementation of the first aspect, in a second possible implementation of the first aspect, the wave-absorbing sheet is formed by plating a light absorbing film or painting a light absorbing coating.

With reference to the first aspect and any possible implementation of the first aspect, in a third possible implementation of the first aspect, a protective cover is arranged above a receiving end face of the receiver module; and

an entrance hole is opened on the protective cover, to enable the second optical signal reflected by the light filtering sheet to transmit to a receiving end of the receiver module.

With reference to the first aspect and any possible implementation of the first aspect, in a fourth possible implementation of the first aspect, an inner wall of the cavity of the component base is pasted with a light absorbing material or is painted with a light absorbing coating.

With reference to the first aspect and any possible implementation of the first aspect, in a fifth possible implementation of the first aspect, the pigtail includes an optical fiber adapter; and an antireflection film is plated on an end face of the optical fiber adapter.

In a second aspect, a built-in optical time domain reflectometer is provided, including the optical component in the first aspect and any possible implementation of the first aspect.

In a third aspect, an optical network device is provided, including the optical component in the first aspect and any possible implementation of the first aspect.

In the embodiments of the present disclosure, the reflecting light guide through-hole is opened on the component base of the optical component, and an opening direction of the reflecting light guide through-hole is an optical path direction that the light filtering sheet reflects the first optical signal. Therefore, the part of first optical signal reflected by the wave filtering sheet can be sent out of the component base directly along the reflecting light guide through-hole, to prevent this part of first optical signal from entering the receiver module after being reflected by the inner wall of the cavity of the component base, thereby effectively preventing the first optical signal reflected by the wave filtering sheet from causing optical crosstalk for the second optical signal received by the receiver module.

### BRIEF DESCRIPTION OF DRAWINGS

To illustrate the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a structural diagram of an optical component according to a first embodiment of the present disclosure; and

FIG. 2 is a structural diagram of an optical component according to a second embodiment of the present disclosure.

### DESCRIPTION OF EMBODIMENTS

Embodiments of the present disclosure provide an optical component, a built-in optical time domain reflectometer, and an optical network device, which can effectively eliminate optical crosstalk in the optical component and improve overall performance of the device.

To enable persons skilled in the art to understand the technical solution in the embodiments of the present disclosure in a better way, and make the objective, features, and advantages of the embodiments of the present disclosure more apparent and understandable, the following further describes the technical solution in the embodiments of the present disclosure in detail with reference to the accompanying drawings.

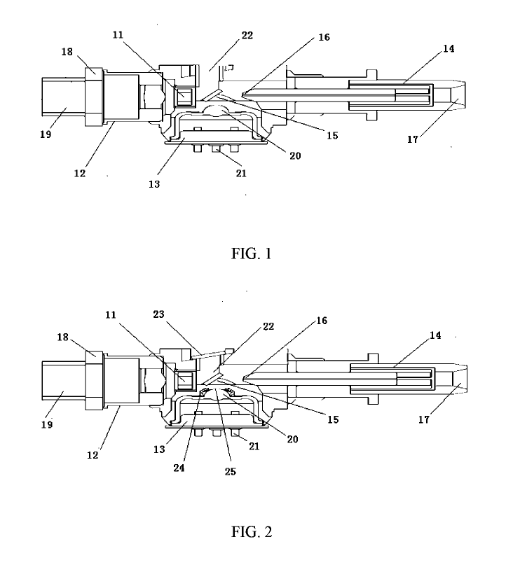

Refer to FIG. 1. FIG. 1 is a structural diagram of an optical component according to a first embodiment of the present disclosure. As shown in FIG. 1, the optical component includes a component base 11, a transmitter module 12, a receiver module 13, and a pigtail 14.

The transmitter module 12, the receiver module 13, and the pigtail 14 are connected to the component base 11.

The component base 11 has a cavity inside, and a wave filtering sheet 15 is provided inside the cavity.

The transmitter module 12 is configured to transmit a first optical signal to the pigtail 14.

The receiver module 13 is configured to receive a second optical signal from the pigtail 14.

The wave filtering sheet 15 is configured to transmit the first optical signal transmitted by the transmitter module 12, to enable the first optical signal to enter the pigtail 14; and is further configured to reflect the second optical signal received by the pigtail 14 to the receiver module 13.

Specifically, the pigtail 14 may have an optical fiber adapter 16 and an optical fiber interface 17. The optical fiber interface 17 is configured to connect an optical fiber.

The transmitter module 12 may have a laser transmitter 18 and a first Flexible Printed Circuit (FPC) interface 19.

The first FPC interface 19 is configured to connect to an external Printed Circuit Board (PCB). The laser transmitter 18 generates the first optical signal and transmits it out after receiving a driving electrical signal sent by the external PCB. The first optical signal is injected inside the cavity of the component base 11, enters the pigtail 14 after being transmitted by the wave filtering sheet 15, converges onto the optical fiber adapter 16, and is transferred to the optical fiber connected to the optical fiber interface 17 through the optical fiber adapter 16. Therefore, a process of bi-directional optical signal emission of the optical component is implemented.

The receiver module 13 may have a photoelectric detector 20 and a second FPC interface 21.

The second FPC interface 21 is configured to connect to an external PCB. The optical fiber adapter 16 receives the second optical signal reflected by the optical fiber, which is connected to the optical fiber interface 17, and transfers and injects the second optical signal inside the cavity of the component base 11. After being reflected by the wave filtering sheet 15, the second optical signal is injected into the photoelectric detector 20. The photoelectric detector 20 receives the second optical signal, converts it into an electrical signal, and outputs it to the PCB connected to the second FPC interface 21. Therefore, a process of bi-directional optical signal reception of the optical component is implemented.

With reference to FIG. 1, after the first optical signal sent by the transmitter module 12 is transmitted by the wave filtering sheet 15, most of the first optical signal can enter the pigtail 14, and converge onto the optical fiber adapter 16. However, a small part of the first optical signal is reflected to an inner wall of the cavity of the component base 11 by the wave filtering sheet 15, and enters the receiver module 13 along an optical path after being reflected by inner wall of the cavity, which causes optical crosstalk for the second optical signal received by the receiver module 13. This part of optical crosstalk is a major part of the optical crosstalk in the optical component.

Based on this, in the optical component of the first embodiment of the present disclosure, a reflecting light guide through-hole 22 is opened on the component base 11 along an optical path direction that the light filtering sheet 15 reflects the first optical signal.

As shown in FIG. 1, the reflecting light guide through-hole 22 is opened on the component base 11, and an opening direction of the reflecting light guide through-hole 22 is the optical path direction that the light filtering sheet 15 reflects the first optical signal. Therefore, the part of first optical signal reflected by the wave filtering sheet 15 can be sent out of the component base 11 directly along the reflecting light guide through-hole 22, to prevent this part of first optical signal from entering the receiver module 13 after being reflected by the inner wall of the cavity of the component base 11, thereby effectively preventing the first optical signal reflected by the wave filtering sheet 15 from causing optical crosstalk for the second optical signal received by the receiver module 13.

In the optical component of the first embodiment of the present disclosure, by opening the reflecting light guide through-hole 22, the first optical signal reflected by the wave filtering sheet 15 can be guided to the outside of the component base 11, the optical crosstalk caused by the first optical signal reflected by the wave filtering sheet 15 for the second optical signal received by the receiver module 13 can be eliminated almost completely, and overall performance of the optical component can be effectively improved. Further, the method for implementing the optical component is simple, and the cost is scarcely increased.

In the first embodiment of the present disclosure, when the reflecting light guide through-hole 22 is opened on the component base 11 of the optical component, for the purpose of preventing the first optical signal that is guided to the outside of the component base 11 and dust from entering inside the cavity of the component base 11 through the reflecting light guide through-hole 22, the reflecting light guide through-hole 22 may be provided with a wave-absorbing sheet additionally. Refer to FIG. 2 for the details.

Refer to FIG. 2. FIG. 2 is a structural diagram of an optical component according to a second embodiment of the present disclosure. As shown in FIG. 2, the reflecting light guide through-hole 22 is provided with a wave-absorbing sheet 23 additionally.

Specifically, the wave-absorbing sheet 23 is provided to prevent the first optical signal that is guided to the outside of the component base 11 and dust from entering the cavity of the component base 11 through the reflecting light guide through-hole 22. At this time, the part of first optical signal reflected by the wave filtering sheet 15 is transmitted towards a side of the wave-absorbing sheet 23 facing the cavity of the component base 11. In order to prevent this part of first optical signal from being reflected to the receiver module 13 by the wave-absorbing sheet 23, the wave-absorbing sheet 23 is designed to absorb almost all the first optical signal that is transmitted to the wave-absorbing sheet 23.

Specifically, the wave-absorbing sheet 23 may be formed by plating a light absorbing film or painting a light absorbing coating.

Therefore, the part of first optical signal reflected by the wave filtering sheet 15 may be transmitted towards the wave-absorbing sheet 23 along the reflecting light guide through-hole 22, and is absorbed by the wave-absorbing sheet 23, to prevent this part of first optical signal from entering the receiver module 13 after being reflected by the inner wall of the cavity of the component base 11, thereby effectively preventing the first optical signal reflected by the wave filtering sheet 15 from causing optical crosstalk for the second optical signal received by the receiver module 13. Further, a good dustproof effect is achieved.

Further, in the optical component described in the foregoing embodiments of the present disclosure, after the first optical signal sent by the transmitter module 12 is transmitted by the wave filtering sheet 15, most of the first optical signal can enter the pigtail 14, and converge onto the optical fiber adapter 16. However, a part of stray light may be reflected by the inner wall of the cavity of the component base 11 to the receiver module 13, which causes optical crosstalk for the second optical signal received by the receiver module 13.

Still with reference to FIG. 2, in the second embodiment of the present disclosure, a protective cover 24 is arranged above a receiving end face of the receiver module 13 (see the part marked by transverse broken lines in FIG. 2). An entrance hole 25 is opened at an upper end of the protective cover 24 (see the disconnected part in the middle of the protective cover 24 in FIG. 2), and the entrance hole 25 can enable a main optical path of the second optical signal to enter the receiver module 13.

As shown in FIG. 2, for the purpose of preventing the stray light reflected by the inner wall of the cavity of the component base 11 from entering the receiving end face of the receiver module 13, the protective cover 24 is arranged above the receiving end face of the receiver module 13 to prevent the stray light from entering. Furthermore, for the purpose of normally receiving the second optical signal reflected by the light filtering sheet 15, the entrance hole 25 is opened on the protective cover 24, and an opening direction of the entrance hole 25 is an optical path direction of the second optical signal reflected by the light filtering sheet 15, thereby effectively ensuring the main optical path of the second optical signal to enter the receiving end face of the receiver module 13.

It should be noted that in the embodiment of the present disclosure, the protective cover 24 may be in any shape like a circle, a square, or a polygon, which may be specifically set according to an inner structure of the optical component. Similarly, the shape of the entrance hole 25 is not limited either, and can be specifically set according to actual requirements, for example, a circle, a square, or a polygon.

Further, the inner wall of the cavity of the component base 11 may be pasted with a light absorbing material or be painted with a light absorbing coating, to enhance light-absorbing performance of the inner wall of the cavity, so that the stray light transmitted to the inner wall of the cavity the component base 11 can be absorbed by the inner wall directly, thereby preventing this part of first optical signal from entering the receiver module 13, and eliminating the optical crosstalk caused by this part of first optical signal for the second optical signal received by the receiver module 13.

Further, in the optical component described in the foregoing embodiments of the present disclosure, after the first optical signal sent by the transmitter module 12 is transmitted by the wave filtering sheet 15, most of the first optical signal can enter the pigtail 14, and converge onto the optical fiber adapter 16. However, since a receiving end of the optical fiber adapter 16 has a reflecting function, which enables a part of the first optical signal to return to the cavity of the component base 11 along the main optical path, and to enter the receiver module 13 after being reflected by the wave filtering sheet 15, which causes optical crosstalk for the second optical signal received by the receiver module 13.

With reference to the optical component described in the foregoing embodiments of the present disclosure, an antireflection film is plated on an end face of the optical fiber adapter 16.

By plating the antireflection film on the end face of the optical fiber adapter 16, the first optical signal may be prevented from being reflected by the end face of the optical fiber adapter 16 to the cavity of the component base 11, thereby effectively preventing this part of reflected light from causing optical crosstalk for the second optical signal received by the receiver module 13, and improving overall performance of the optical component.

It should be noted that the optical component described in the foregoing embodiments of the present disclosure is applicable to transferring both parallel light and non-parallel light; and can be used as the optical component of a same wavelength to eliminate intraband optical crosstalk, or be used as the optical component of different wavelengths to eliminate interband optical crosstalk.

The optical component provided in the foregoing embodiments of the present disclosure can be applied to the built-in OTDR, effectively eliminate optical crosstalk in the optical component of the built-in OTDR and improve overall performance of the built-in OTDR.

An embodiment of the present disclosure further provides an optical network device, which includes the optical component described in the foregoing embodiments of the present disclosure.

The embodiments of the present disclosure are described in a progressive manner. Reference may be made for same or similar parts of the embodiments, and each embodiment emphasizes differences from other embodiments. Particularly, since the system embodiment is basically similar to the method embodiment, its description is simple, and relevant parts of the method embodiment may be referenced.

The foregoing embodiments of the present disclosure do not limit the protection scope of the present disclosure. Any modification, equivalent replacement, or improvement made within the spirit and principle of the present disclosure shall fall within the protection scope of the present disclosure.

What is claimed is:

1. An optical component, comprising:
a component base having a cavity, wherein a wave filtering sheet is provided inside the cavity;
a transmitter module connected to the component base;
a receiver module; and
a pigtail,
wherein the transmitter module is configured to transmit a first optical signal to the pigtail,
wherein the receiver module is configured to receive a second optical signal from the pigtail,
wherein the wave filtering sheet is configured to transmit the first optical signal transmitted by the transmitter module, to enable the first optical signal to enter the pigtail, and is further configured to reflect the second optical signal received by the pigtail to the receiver module, and
wherein a reflecting light guide through-hole is opened on the component base along an optical path direction that the light filtering sheet reflects the first optical signal.

2. The optical component according to claim 1, wherein the reflecting light guide through-hole includes a wave-absorbing sheet.

3. The optical component according to claim 2, wherein the wave-absorbing sheet is formed by plating a light absorbing film or painting a light absorbing coating.

4. The optical component according to claim 1, wherein:
a protective cover is arranged above a receiving end face of the receiver module; and
an entrance hole is opened on the protective cover, to enable the second optical signal reflected by the light filtering sheet to transmit to a receiving end of the receiver module.

5. The optical component according to claim 1, wherein an inner wall of the cavity of the component base is pasted with a light absorbing material or is painted with a light absorbing coating.

6. The optical component according to claim 1, wherein the pigtail comprises an optical fiber adapter, and an antireflection film is plated on an end face of the optical fiber adapter.

7. A built-in optical time domain reflectometer, comprising an optical component, wherein the optical component comprises:
a component base having a cavity, wherein a wave filtering sheet is provided inside the cavity;
a transmitter module connected to the component base;
a receiver module; and
a pigtail,
wherein the transmitter module is configured to transmit a first optical signal to the pigtail,
wherein the receiver module is configured to receive a second optical signal from the pigtail,
wherein the wave filtering sheet is configured to transmit the first optical signal transmitted by the transmitter module, to enable the first optical signal to enter the pigtail, and is further configured to reflect the second optical signal received by the pigtail to the receiver module, and
a reflecting light guide through-hole is opened on the component base along an optical path direction that the light filtering sheet reflects the first optical signal.

8. An optical network device, comprising an optical component, wherein the optical component comprises:
a component base having a cavity, wherein a wave filtering sheet is provided inside the cavity;
a transmitter module connected to the component base;
a receiver module; and
a pigtail,
wherein the transmitter module is configured to transmit a first optical signal to the pigtail,
wherein the receiver module is configured to receive a second optical signal from the pigtail,
wherein the wave filtering sheet is configured to transmit the first optical signal transmitted by the transmitter module, to enable the first optical signal to enter the pigtail; and is further configured to reflect the second optical signal received by the pigtail to the receiver module, and
wherein a reflecting light guide through-hole is opened on the component base along an optical path direction that the light filtering sheet reflects the first optical signal.
